(19) United States
(12) Patent Application Publication
(10) Pub. No.: US 2009/0158346 A1
(43) Pub. Date: Jun. 18, 2009

(54) AUTOMATIC SMART VIDEO USER GENERATED URL SYNTHESIS INTO A CHANNEL LIST

(76) Inventors: Yoram Zer, Givatayim (IL); Moti Ben Yosef, Shoham (IL); Zohar Iarchy, Rishon Lezion (IL)

Correspondence Address: Appelfeld Zer Fisher;B.S.R Tower 1, Floor 16, 2 Ben Gurion Road, Ramat Gan, 52573, IL

(21) Appl. No.: 12/336,575

(22) Filed: Dec. 17, 2008

Related U.S. Application Data
(60) Provisional application No. 61/014,093, filed on Dec. 17, 2007.

(51) Int. Cl. H04N 5/445

(52) U.S. Cl. 725/47

(57) ABSTRACT

A system and method for defining and organizing personal viewing channels, wherein the channel sources are aggregated from a data communication network. The system comprises a channel selection utility enabling to select specific and video content sources through on the fly navigation session and store all meta data associated with the video source, wherein said meta data supports the viewing of said video source; an editor web application enabling to organize the selected video sources according to user personal categories, wherein all video source metadata is maintained on a dedicated server; and a converter module which enables to assign at least one selected video source to at least one TV channel. Upon user selection of a channel the system automatically retrieves all meta data of the respective video source and activates required application for viewing of said respective video source.

### CROSS REFERENCE TO RELATED APPLICATION

This application claims the benefit of U.S. Provisional Patent Application 61/014,093 filed on Dec. 17, 2007, which is incorporated herein by reference.

### TECHNICAL FIELD

The present invention relates to the field of generating and managing links to video content pages, analyzing the page content and transforming the links into a channel based list to be later accessed and viewed by the user simulating a channel browse and watch experience.

### BACKGROUND OF THE RELATED ART

The need to access content over the internet is shared by all the “surfers” of the third millennium. There are various ways to search and store the URL's (Unique Reference Locater) to the content but the integration into one simple and easy to access list is still a problem looking for a solution. The suggested solution provides an effective way to create a personalized viewing channel list based on the user preferences and experience to be later viewed on a TV, or a PC. Storing just the URL is not enough, the information behind the URL is not enough to create a meaningful menu entry.

Prior to setting forth the background of the related art, it may be helpful to set forth definitions of certain terms that will be used hereinafter.

The term “IPTV Internet protocol television” as used herein in this application, is defined as the method of delivering pictures, sound and media content on demand over an IP network.

The term “Middleware” as used herein in this application, is defined as the command-and-control center of the interactive TV environment which defines and manages the overall TV environment, and subscriber experience.

The term “User Information” as used herein in this application, is defined as comprising information about the user, such as gender, age, preferences, preferred tags, mood (questioned or derived).

The term “Browsing Information” as used herein in this application, is defined as information related to browsed websites, including information related to within page browsing and user action, as well as user characteristics related to browsing.

The term “Media Information” as used herein in this application, is defined as media related information such as popularity, hits, plays, related, tags, and is usually derived from the web page.

The term “Viewing Information” as used herein in this application, is defined as information relating to characteristics of viewing video content by the user, such as viewing time, frequency and completion.

### BRIEF SUMMARY

Embodiments of the present invention provide a system for defining and organizing personal viewing channels, wherein the channel sources are aggregated from a data communication network—e.g. for defining a URL on the fly through a browsing session. The system comprises a channel selection utility enabling to select specific and video content sources through on the fly navigation session and store all meta data associated with the video source, wherein said meta data supports the viewing of said video source. The system further comprises an editor web application enabling to organize the selected video sources according to user personal categories, wherein all video source metadata is maintained on a dedicated server. The system further comprises a converter module which enables to assign at least one selected video source to at least one TV channel. Upon user selection of a channel the system automatically retrieves all meta data of the respective video source and activates required application for viewing of said respective video source.

In embodiments, the editor web application further enables the user to define set of rules of automatic selection and aggregation of video sources according to subject categories, time parameters and context of video source.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a high level block diagram illustrating a system for defining and organizing personal viewing channels, wherein the channel sources are aggregated from a data communication network, and the environment in which the present invention is practiced, according to some embodiments of the invention;

FIG. 2 is a high level flowchart illustrating the method and process of selecting, aggregating and storing of video sources and creating viewing channels, according to some embodiments of the invention;

FIG. 3 is a high level flowchart illustrating the method and process of activating the viewing channels and playing the video source content, according to some embodiments of the invention; and

FIG. 4 is a high level schematic block diagram of the system, according to some embodiments of the invention.

The drawings together with the following detailed description make apparent to those skilled in the art how the invention may be embodied in practice.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The term “video content” as used herein in this application, is defined as viewable content that may be displayed of a viewing terminal, including related audio and multimedia content and data. Video content may be made viewable by downloading, streaming, accumulated streaming, using a predefined software or hardware, or a combination thereof.

The term “metadata information” as used herein in this application, is defined as all data used to identify a video content on a web page. Metadata information may comprise a URL of the video content, a path of choices within a web page or a website directed at a video content, identification data of the video content, video source and browsing user, and any other data allowing the identification and selection of a video content. Metadata information may comprise IPTV Internet protocol television which defines the method of delivering pictures, sound and media content on demand over an IP network, middleware which includes the command-and-control center of the interactive TV environment which defines and manages the overall TV environment, and subscriber experience which include browsing information site such as history session. Other metadata information may comprise personalization information such a gender, age, preferences, preferred tags and mood (which may be acquired by questionnaire or derived from other data personalization sources).

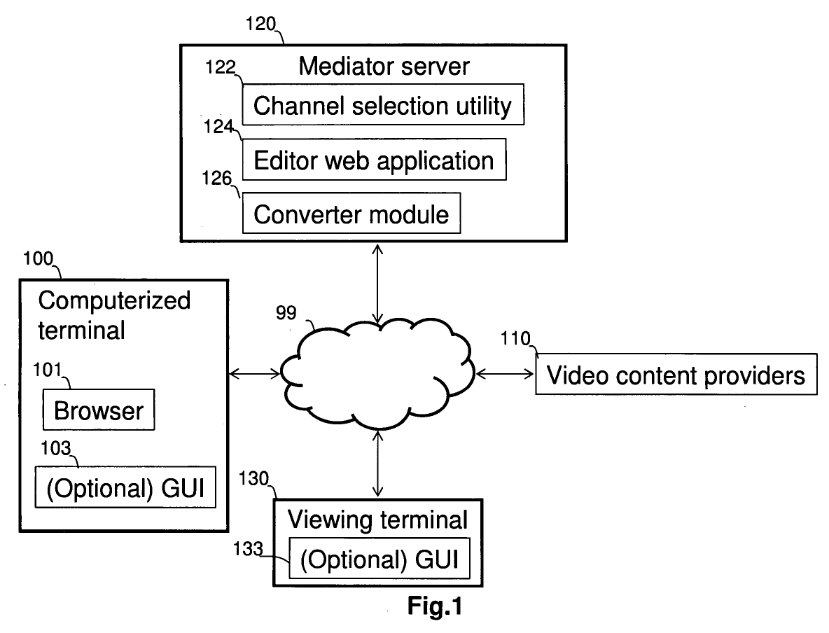

FIG. 1 is a high level block diagram illustrating a system for defining and organizing personal viewing channels, wherein the channel sources are aggregated from a data communication network, and the environment in which the present invention is practiced, according to some embodiments of the invention. A computerized terminal comprising a computerized terminal 100 with a browser 101 connected via a communication link 99 (e.g. the internet) to a mediator server 120, a video content providers 110 and a viewing terminal 130. Browser 101 may comprise a browsing application including a dedicated utility for selecting video sources and aggregating relevant metadata information. Video content may be received from video content providers 110 utilizing any method (e.g. downloading, streaming, accumulating streaming data etc.) and in relation to metadata information relating to the video content, as defined by the user or browsing application during the selection of the video content. Mediator server 120 may be arranged to connect with computerized terminal 100 and browser 101 and receive data relating to selected video content and metadata information such as data inputted by the user while selecting the video content. Mediator server 120 may be arranged to receive the selected video content from video content providers 110 upon user request or in advance, using the received metadata information related to the selected video content. Mediator server 120 may be further arranged to deliver the selected video content to viewing terminal 130 upon user preferences, e.g. in predefined channels or settings. Mediator server 120 may be further arranged to manage a large number of users, video content from various video content providers 110 and a large number of viewing terminals 130.

According to some embodiments of the invention, mediator server 120 may be further arranged to allow the user to define preferences relating to the arrangement of various video contents.

According to some embodiments of the invention, mediator server 120 may be further arranged to learn actions associated with receiving the video content from the video source, such as reformatting, extracting parts, synchronizing, dubbing.

According to some embodiments of the invention, mediator server 120 may be further arranged to support a graphical user interface 103 on computerized terminal 100 allowing the user to select video content and set user preferences in relation to video content.

According to some embodiments of the invention, viewing terminal 130 may be arranged to display content that is organized in various channels, and mediator server 120 may be further arranged to sort the video content in relation to the various channels, e.g. relating a video content comprising a drama film with a drama channel etc.

According to some embodiments of the invention, mediator server 120 may be arranged to support a graphical user interface 133 on viewing terminal 130 allowing the user to select video content and set user preferences in relation to video content.

According to some embodiments of the invention, mediator server 120 comprises a channel selection utility 122 enabling to select specific and video content sources through on the fly navigation session and store all meta data and metadata information associated with the video source and supporting the viewing of the video content from the video source.

According to some embodiments of the invention, mediator server 120 may be arranged to learn requirements of different video sources for presenting video content. The requirements may be learned through any of the following ways and their combinations: (i) Learning via user experience—following user actions and imitating them (e.g. registration, selections, GUI related actions). (ii) Learning via initial manual configuration of new sources and application of the learned routines for future uses of each video source. (iii) Data supplied by video content providers (e.g. in order to enhance usage of their video sources).

According to some embodiments of the invention, mediator server 120 comprises an editor web application 124 enabling to organize the selected video sources according to user personal categories. All video source metadata is maintained on mediator server 120. According to some embodiments of the invention, editor web application 124 further enables the user to define a set of rules of automatic selection and aggregation of video sources according subject categories, time parameters and context of video source.

According to some embodiments of the invention, mediator server 120 comprises a converter module 126 which enables to assign at least one selected video source to at least one TV channel. Upon user selection of a channel the system automatically retrieves all meta data of the respective video source and activates the required application for viewing of the respective video content from the video source.

According to some embodiments of the invention, the system provides a dynamic and personal channel viewing and channel creation system where the content origins from existing internet services but the channel content is created by the user on the fly as it accesses the site. The channel content creation may combine the user's preferences, the dynamic search for content (browsing, direct link and search) and the information contained by the internet site.

The system may combine all this information into one clean and easy channel browsing and viewing experience. Matching the user preferences with the browsing session information (search, direct access or opportunistic) with the web page context with actual media content can create the ultimate private channel list.

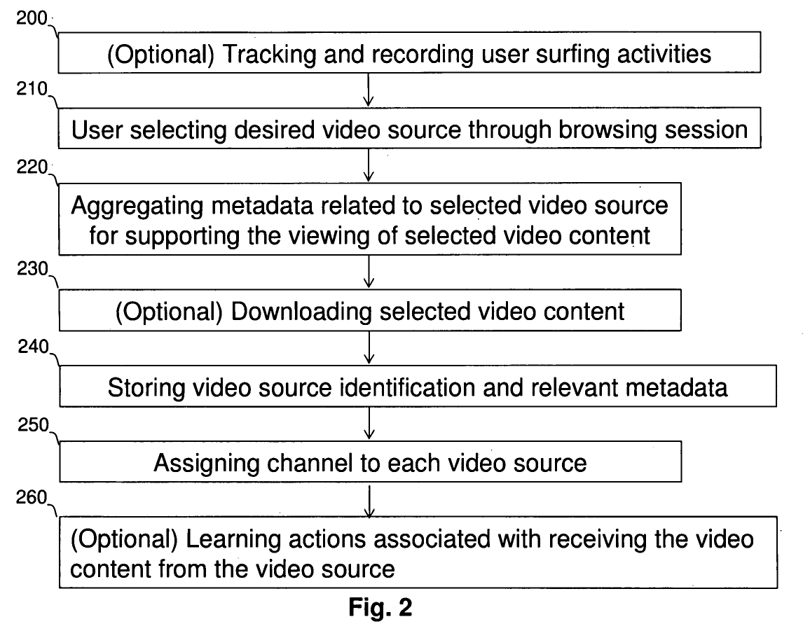

FIG. 2 is a high level flowchart illustrating the method and process of managing video content by a server in relation to a user's computerized terminal and to the user's viewing terminal, according to some embodiments of the invention. The method comprises the stages: allowing a user to select a desired video source and video content through browsing session on the computerized terminal (stage 210); aggregating metadata related to selected video source for supporting the viewing of selected video content (stage 220); storing video source identification and relevant metadata on the server (stage 240); and assigning channel of the viewing terminal to each video source (stage 250). The user is allowed to view the selected video content using the channel of the viewing terminal.

According to some embodiments of the invention, user selecting desired video source through browsing session (stage 210) is preformed through normal surfing session, while the user is navigating between web pages. Once the user comes across interesting video source, the user selects the video source URL using a channel selection utility. As result of the user's selection, the utility identifies the video source configuration setting, format and software requirements for viewing the video source.

According to some embodiments of the invention, aggregating metadata related to selected video source for supporting the viewing of said video (stage 220) comprises aggregating all this information (e.g. video source configuration setting, format and software requirements for viewing the video source) and is followed by storing video source identification and relevant metadata (stage 240).

According to some embodiments of the invention, aggregating metadata related to selected video source for supporting the viewing of said video (stage 220) may comprise learning requirements of different video sources for presenting video content. The requirements may be learned through any of the following ways and their combinations: (i) Learning via user experience—following user actions and imitating them (e.g. registration, selections, GUI related actions). (ii) Learning via initial manual configuration of new sources and application of the learned routines for future uses of each video source. (iii) Data supplied by video content providers (e.g. in order to enhance usage of their video sources).

According to some embodiments of the invention, metadata may comprise the following information: IPTV Internet protocol television which define the method of delivering pictures, sound and media content on demand over an IP network, Middleware which include the command-and-control center of the interactive TV environment which defines and manages the overall TV environment, and subscriber experience which include browsing Information Site such as history session. Other metadata may include personalization information such a Gender Age, preferences, preferred tags and Mood (which is acquired by questionnaire or derived from other data personalization sources).

According to some embodiments of the invention, assigning channel to each video source (stage 250) may comprise defining the appropriate channel to be assigned to the each selected video content. Channels may be organized in a hierarchical tree according to categories which may be predefined according to user preferences or be set by a TV supplier such as a cable firm or satellite supplier. In the latter case, video content selected by the user may be added to existing channels in relation to their content.

According to some embodiments of the invention, the method further comprises tracking and recording user surfing activities (stage 200) allowing aggregating metadata information (stage 220) as well as data relating to the user for creating a user profile. The user profile may be further used to search for potentially relevant video content independently and suggesting this content to the user. The user profile may be used to generate or retrieve user related information such as relevant advertisements. The user profile may be used to generate various statistics allowing the prediction of user behavior, clustering of user groups and improving the efficiency of the method.

According to some embodiments of the invention, the method further comprises downloading selected video content (stage 230) and preparing the video content for use. Downloading may be performed before the user actually views the video content, sparing the user the management of the downloading.

According to some embodiments of the invention, the method further comprises learning actions associated with receiving the video content from the video source (stage 260), such as reformatting, extracting parts, synchronizing, dubbing, and so forth.

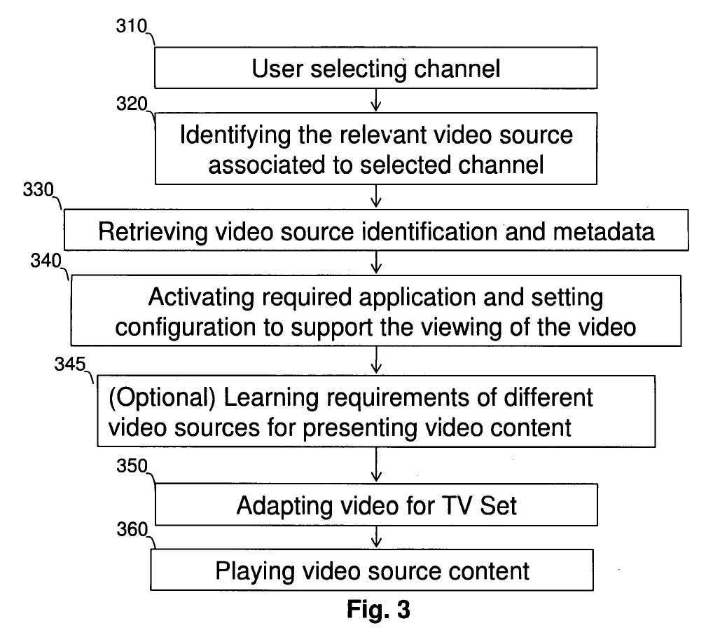

FIG. 3 is a high level flowchart illustrating the method and process of activating the viewing channels and playing the video source content, according to some embodiments of the invention.

The method comprises the stages: User selecting channel (stage 310); identifying the relevant video source associated to selected channel (stage 320); retrieving video source identification and metadata (stage 330); activating required application and setting configuration to support the viewing of the video (stage 340); adapting video for TV Set (stage 350); and playing video source content (stage 360).

According to some embodiments of the invention, user selecting channel (stage 310) is carried out by the user just having to click on the desired channel and the method identifies the relevant video source by identifying the relevant video source associated to selected channel (stage 320). The viewing may be accomplished through real time video stream or by downloading the content to the user computer according to the available options of the specific video source.

According to some embodiments of the invention, the method may further comprise learning requirements of different video sources for presenting video content (stage 345). The requirements may be learned through any of the following ways and their combinations: (i) Learning via user experience—following user actions and imitating them (e.g. registration, selections, GUI related actions). (ii) Learning via initial manual configuration of new sources and application of the learned routines for future uses of each video source. (iii) Data supplied by video content providers (e.g. in order to enhance usage of their video sources).

According to further embodiments of the present invention the selection process may enable the user to define rules and categories for selecting of preferred video content within internet portal which includes large amount of video content. For example the user may select a major portal of animation videos, the video content is organized according to subject categories and/or according the names of the of video authors, the selection process enable the user define a rule for various video sources according to category or time parameters. For example, the user may be allowed to select each new video sources for specific categories. Hence the channel may include dynamic content which is updated according to the rules as defined by the user. The rules may relate to context of the video source according to the title of the video or any other information which is related to available video sources, e.g. actors names, news subject etc.

According to some embodiments of the invention, the method is a convenient method for viewing videos which are available through the internet. Each video source in the internet has different proprieties and setting, and usually demands activating specific video players adapted to the video source format, hence the user is required to be familiar with numerous applications and configurations setting to be able to enjoy the various type of video sources.

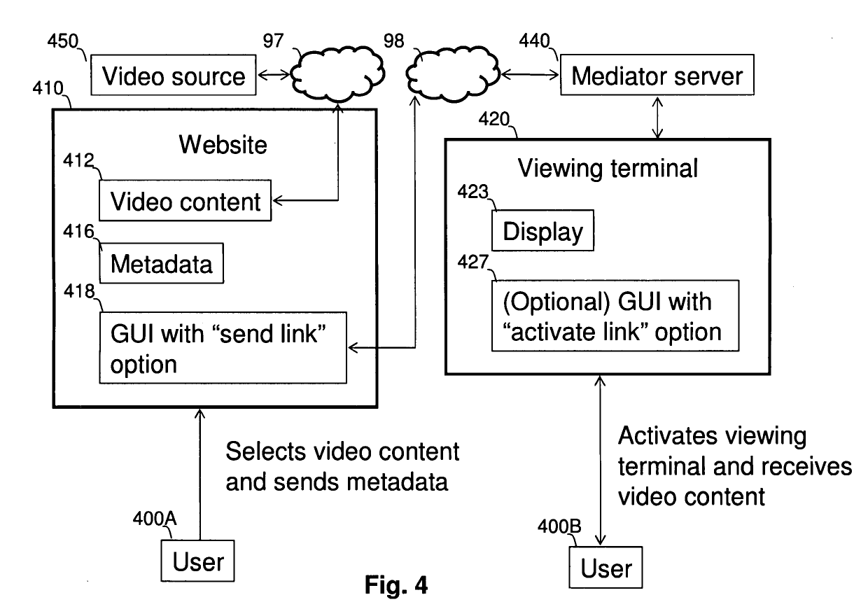

FIG. 4 is a high level schematic block diagram of the system, according to some embodiments of the invention. User 400A browses a website 410. Upon finding interesting video content 412 on a video source 450 (reachable e.g. via a communication link 97), user 400A may utilize a GUI (Graphical User Interface) 418 to send metadata 416 relating to video content 412 via a communication link 98 to a mediator server 440. Metadata 416 may comprise a URL of website 410 and access information within website 410, such as choices and registration data. Mediator server 440 may enable viewing video content 412 at a viewing terminal 420 associated with the user. User 400B, e.g. upon arriving at home, may activate viewing terminal 420 and view video content 412 on a display 423 of viewing terminal 420. An additional GUI 427 may allow user 400B to activate advanced features such as selecting other video content from the same video source 450, switching actively between different video contents 412, accessing webpage 410 etc.

According to some embodiments of the invention, video content 412 may be accessed and viewed either via mediator server 440 (e.g. over a communication link), via viewing terminal 420 or via both.

According to some embodiments of the invention, additional GUI 427 may be embedded in either mediator server 440 or viewing terminal 420 or both. Additional GUI 427 may be made available as a webpage. Additional GUI 427 may be hosted on mediator server 440. Advanced features and video content 412 viewing may be controlled by either mediator server 440 user 400B or both. User 400B may be allowed to override mediator server 440's decisions during any process.

According to some embodiments of the invention, mediator server 440 may be arranged to handle various actions relating to receiving video content 412 from video source 450. These may include changing data formats, selecting subtitles or dubbing, handling various content related restrictions and so forth.

According to some embodiments of the invention, the system combines a regular browsing session with discovery of an interesting web page that contains live or stored video/music contents. The user decides that a web page is worth viewing in is private time and places by the means of a dedicated system that can connect and download the content through a e.g. broad band connection, or by the browsing system. The user accesses the web page and marks the page by using a proprietary designed process. The application collects data from the user and from the web page and adds all the necessary information into one detailed information meta-data. The information is transferred to a dedicated server (in the internet) that is aware of the user's preferences and habits. The information is processed and is translated in to a specific entry with the necessary information to be appended to the user's channel list. The channel list is stored on the server and is used to update the personal channel list used by the user. At a latter time the user will download the channel list to an internet enabled player/set top box to access the URL and view or listen to the content. This channel list is personal and has only sites related to the user's choice.

According to some embodiments of the invention, the system and method provide a one click automatic channel viewing GUI imitating the experience of viewing TV.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for defining and organizing personal viewing channels, wherein the channel sources are aggregated from a data communication network, said system comprised of:
channel selection utility enabling to select specific and video content sources through on the fly navigation session and store all meta data associated with the video source, wherein said meta data supports the viewing of said video source;
editor web application enabling to organize said selected video sources according to user personal categories, wherein all video source metadata is maintained on a dedicated server; and
converter module which enables to assign at least one selected video source to at least one TV channel,
wherein upon user selection of a channel the system automatically retrieves all meta data of the respective video source and activates required application for viewing of said respective video source.

2. The system of claim 1, wherein the editor web application further enables the user to define set of rules of automatic selection and aggregation of video sources according subject categories, time parameters and context of video source.

3. The system of claim 1, wherein the editor web application is further arranged to download at least part of the video content prior to its delivery.

4. The system of claim 1, wherein the channel selection utility is further arranged to allow user define preferences relating to the arrangement of various video contents.

5. The system of claim 1, wherein the editor web application is further arranged to learn actions associated with receiving the video content from the video source.

6. A method of managing video content by a server in relation to a user's computerized terminal and to the user's viewing terminal, the method comprising:
allowing a user to select a video source and video content during a browsing session on the computerized terminal;
aggregating metadata related to selected video source for supporting the viewing of selected video content;
storing video source identification and relevant metadata on the server; and
assigning a channel of the viewing terminal to each video source.
wherein the user is allowed to view the selected video content using the channel of the viewing terminal.

7. The method of claim 6, further comprising tracking and recording user surfing activities.

8. The method of claim 6, further comprising downloading selected video content.

9. The method of claim 6, further comprising enabling the user to define rules and categories for selecting of preferred video content.

10. The method of claim 6, further comprising learning actions associated with receiving the video content from the video source.

11. The method of claim 6, further comprising learning requirements of different video sources for presenting video content.

12. A system for managing video content from at least one video content provider according to user preferences, the system comprising:
a computerized terminal comprising a browser and connected via a communication link to the at least one video content provider;
a mediator server connected via the communication link to the computerized terminal and to the at least one video content provider; and
a viewing terminal connected via the communication link to the mediator server,
wherein the computerized terminal is arranged to allow a user to find video content from the at least one video content provider;
wherein the mediator server is arranged receive from the computerized terminal metadata information relating to the video content; and
wherein the mediator server is further arranged to utilize the metadata information to retrieve the video content from the at least one video content provider and to deliver the video content to the viewing terminal according to the user preferences.

13. The system of claim 12, wherein the mediator server is further arranged to download at least part of the video content prior to its delivery.

14. The system of claim 12, wherein the mediator server is further arranged to allow user define preferences relating to the arrangement of various video contents.

15. The system of claim 12, wherein the mediator server is further arranged to learn actions associated with receiving the video content from the video source.

16. The system of claim 12, wherein the viewing terminal is arranged to display content that is organized in a plurality of channels, and wherein the mediator server is further arranged to sort video content in relation to the plurality of channels.

17. The system of claim 12, wherein the mediator server is further arranged to support a graphical user interface on the computerized terminal allowing the user to select video content and set user preferences in relation to video content.

18. The system of claim 12, wherein the mediator server is further arranged to support a graphical user interface on the viewing terminal allowing the user to select video content and set user preferences in relation to video content.

19. The system of claim 12, wherein the mediator server is further arranged to learn requirements of different video sources for presenting video content.
